(19) United States
(12) Patent Application Publication
(10) Pub. No.: US 2024/0378467 A1
(43) Pub. Date: Nov. 14, 2024

(54) QUANTIFYING RELEVANCY OF RESOURCES USING ARTIFICIAL INTELLIGENCE TECHNIQUES

(71) Applicant: Dell Products L.P., Round Rock, TX (US)

(72) Inventor: Siamak Saliminejad, Austin, TX (US)

(21) Appl. No.: 18/196,125

(22) Filed: May 11, 2023

(51) Int. Cl. G06N 5/02

(52) U.S. Cl. CPC G06N 5/027

(57) ABSTRACT

Methods, apparatus, and processor-readable storage media for quantifying relevancy of resources using artificial intelligence techniques are provided herein. An example computer-implemented method includes determining relevancy factor(s) for at least one category of resources based on user input; defining relevancy-based membership function(s) associated with the at least one category of resources based on at least a portion of the relevancy factor(s); configuring artificial intelligence technique(s) based on at least a portion of the relevancy-based membership function(s) and inference rule(s); quantifying relevancy of at least a first resource associated with the at least one category of resources relative to at least a second resource associated with the at least one category by processing data pertaining to the at least a first resource and data pertaining to the at least a second resource using the artificial intelligence technique(s); and performing automated action(s) based on the quantified relevancy.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to resource management in such systems.

### BACKGROUND

With an increasing number of resources utilized within and offered by enterprises, determining relevancy of various resources within and across enterprises presents challenges. However, conventional resource management techniques are overinclusive with respect to processing resources, relying on static rules and/or labor-intensive manual efforts to exclude potentially less relevant resources from analysis. Accordingly, such conventional techniques are error-prone and often produce inaccurate and/or inconsistent results in connection with related processing tasks.

### SUMMARY

Illustrative embodiments of the disclosure provide techniques for quantifying relevancy of resources using artificial intelligence techniques.

An exemplary computer-implemented method includes determining one or more relevancy factors for at least one category of resources based at least in part on user input pertaining to the at least one category of resources, and defining one or more relevancy-based membership functions associated with the at least one category of resources based at least in part on at least a portion of the one or more relevancy factors. The method also includes configuring one or more artificial intelligence techniques based at least in part on at least a portion of the one or more relevancy-based membership functions and one or more inference rules. Additionally, the method includes quantifying relevancy of at least a first resource associated with the at least one category of resources relative to at least a second resource associated with the at least one category by processing data pertaining to the at least a first resource and data pertaining to the at least a second resource using the one or more artificial intelligence techniques. Further, the method also includes performing one or more automated actions based at least in part on the quantified relevancy.

Illustrative embodiments can provide significant advantages relative to conventional resource management techniques. For example, problems associated with error-prone and labor-intensive efforts are overcome in one or more embodiments through automatically quantifying the relevancy of various resources by configuring and implementing one or more artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for quantifying relevancy of resources using artificial intelligence techniques in an illustrative embodiment.

FIG. 2 shows an example workflow for implementing an artificial intelligence model to quantify relevancy of resources in an illustrative embodiment.

FIG. 3 shows an example graph depicting fuzzy membership of resource parameter differences in an illustrative embodiment.

FIG. 4 shows an example graph depicting fuzzy membership in connection with resource quality in an illustrative embodiment.

FIG. 5 shows example pseudocode for implementing a fuzzy model to quantify relevancy of resources using in an illustrative embodiment.

FIG. 6 is a flow diagram of a process for quantifying relevancy of resources using artificial intelligence techniques in an illustrative embodiment. FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

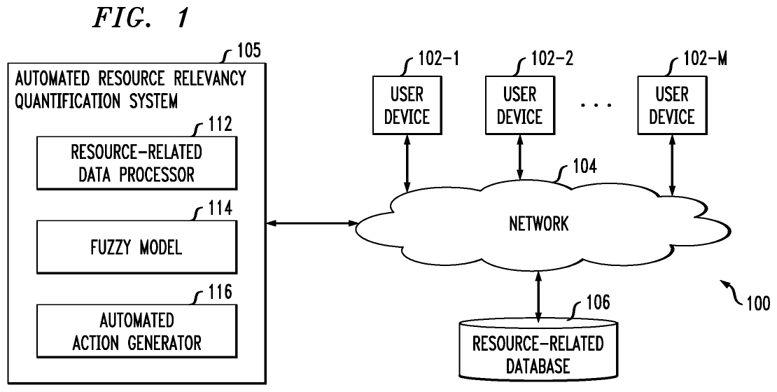

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource relevancy quantification system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated resource relevancy quantification system 105 can have an associated resource-related database 106 configured to store data pertaining to various resources and variables thereof, including, for example, price and/or value data, specification data, usage data, etc.

The resource-related database 106 in the present embodiment is implemented using one or more storage systems associated with automated resource relevancy quantification system 105.

Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated resource relevancy quantification system 105 are one or more input-output devices, which illustratively comprise keyboards, displays or other types of input-output devices in any combination. Such input-output devices can be used, for example, to support one or more user interfaces to automated resource relevancy quantification system 105, as well as to support communication between automated resource relevancy quantification system 105 and other related systems and devices not explicitly shown.

Additionally, automated resource relevancy quantification system 105 in the FIG. 1 embodiment is assumed to be implemented using at least one processing device. Each such processing device generally comprises at least one processor and an associated memory, and implements one or more functional modules for controlling certain features of automated resource relevancy quantification system 105.

More particularly, automated resource relevancy quantification system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated resource relevancy quantification system 105 to communicate over the network 104 with the user devices 102, and illustratively comprises one or more conventional transceivers.

The automated resource relevancy quantification system 105 further comprises resource-related data processor 112, fuzzy model 114, and automated action generator 116.

It is to be appreciated that this particular arrangement of elements 112, 114 and 116 illustrated in the automated resource relevancy quantification system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for quantifying relevancy of resources using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated resource relevancy quantification system 105 and resource-related database 106 can be on and/or part of the same processing platform.

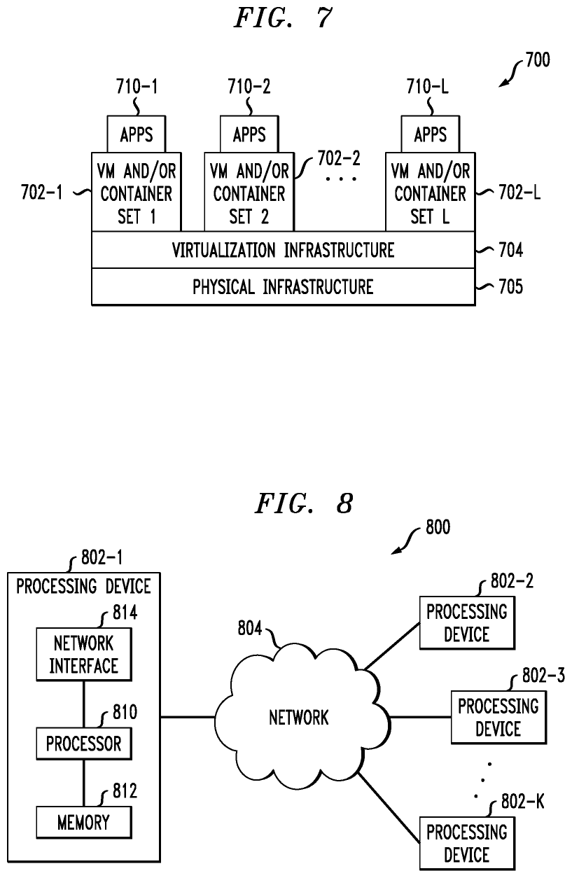

An exemplary process utilizing elements 112, 114 and 116 of an example automated resource relevancy quantification system 105 in computer network 100 will be described in more detail with reference to the flow diagram of FIG. 6.

Accordingly, at least one embodiment includes identifying and quantifying relevancy of resources using artificial intelligence techniques. For example, such an embodiment can include using historical resource-related data to build and/or train at least one fuzzy model that quantifies levels of matching and/or similarity between one or more resources of a given enterprise and one or more resources of one or more additional enterprises. If a model-produced score is below a predetermined threshold, then the resource in question from the one or more additional enterprises is identified as potentially an anomaly (e.g., relative to the resource in question of the given enterprise).

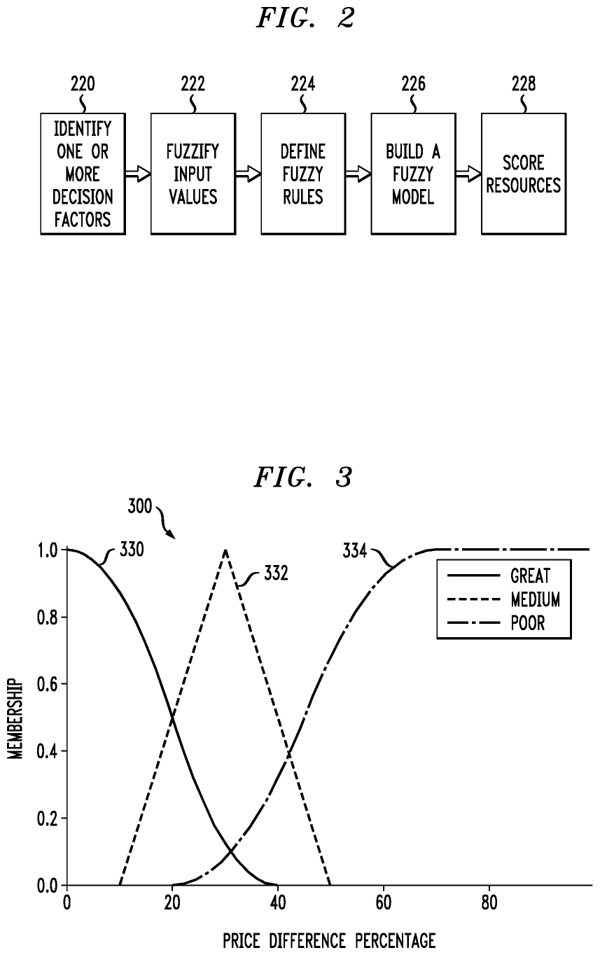

FIG. 2 shows an example workflow for implementing an artificial intelligence model to quantify relevancy of resources in an illustrative embodiment. By way of illustration, step 220 includes identifying one or more decision factors. Such decision factors can represent, for example, resource details and/or variables which facilitate determining areas of distinction across resources. For example, such decision factors can include hardware specifications (e.g., type of hard drive(s), type and/or amount of memory, type of display technology, etc.), value and/or pricing assessments and/or related information, resource user base information, etc.

Step 222 includes fuzzifying one or more input values by defining one or more membership functions (e.g., using user feedback data, incorporating opinions of subject matter experts, etc.). As used herein, fuzzification refers to a process of converting an input value to a fuzzy value, wherein such a conversion is performed using information in at least one knowledge base. By way of example, fuzzifying an input temperature value can include converting a numerical temperature value to a fuzzy value/concept of “cold.” For instance, a fuzzification function converts an input value of 43 degrees Fahrenheit into 0.5 “cold,” such that the input value can be read as 43 degrees Fahrenheit and/or considered half-way/partially “cold.”

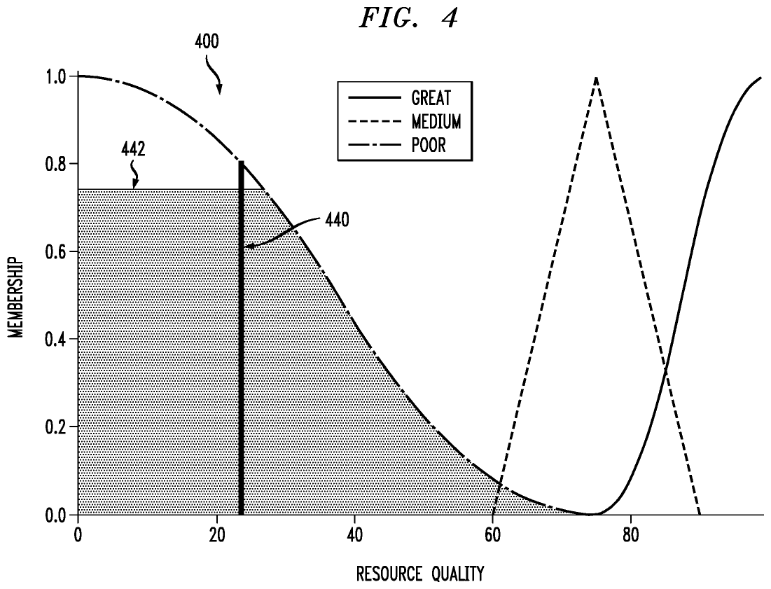

FIG. 3 shows an example graph 300 depicting fuzzy membership of resource parameter differences in an illustrative embodiment. Specifically, graph 300 depicts fuzzy membership of various price differences (price difference percentage) across similar resources (e.g., hardware products). By way of illustration, in graph 300, curve 330 shows the fuzzy membership of the “great” price difference, curve 332 shows the fuzzy membership of the “medium” price difference, and curve 334 shows the fuzzy membership of the “poor” price difference. As used in the context of graph 300, “poor,” “medium,” and “great” refer to how, on average, subject matter experts (also referred to as pricers) describe the similarity of a particular enterprise product with a particular competitor product.

More specifically, graph 300 indicates that a price difference of 30% has a high membership value, meaning that it is considered “medium” by a majority of pricers in a majority of cases. In other words, if an enterprise product has particular price differences with a competitor product, pricers may not typically highly value (or agree as to the value) that competitor as a competitor because there is a sufficiently high price difference. However, as represented in graph 300, pricers agree less as the price difference moves further from 30% (in either direction).

More specifically, referring to graph 300, with a price difference of 30%, the “medium” curve 332 shows a high membership value (close to 1) but “great” curve 330 and “poor” curve 334 show low membership values (close to 0) at a price difference of 30%. But as the price difference increases from 30%, for example, to 40%, both the “poor” curve 334 and the “medium” curve 332 show similar membership values, meaning that some pricers think that this competitor and/or product is a poor match while others think this competitor and/or product is a medium match. This can be viewed as similar, for example, to a scenario wherein the temperature is 40 degrees and some people think it is cold and other people think it is mild. As also depicted in graph 300, at a price difference of 0%, the “great” curve 330 has high membership values, meaning that if the given enterprise's product and the competitor's product have a 0% price difference, all pricers agree that this is a great match.

Referring again to FIG. 2, step 224 includes defining one or more fuzzy rules. Such rules can represent and/or be based in part on, for example, pricers' subjective opinions extracted through interviews and/or other data sources. Accordingly, in one or more embodiments, such fuzzy membership functions are constructed based at least in part on pricers' opinions. For example, at price difference of 30%, such functions can be based at least in part on what percentage of pricers view that as a medium match versus a poor match, etc.

Step 226 includes building a fuzzy model using, for example, at least a portion of the one or more membership functions defined in step 222 and at least a portion of the one or more fuzzy rules defined in step 224. In at least one embodiment, to build the fuzzy model, the fuzzy rules defined in step 224 are applied to one or more calculated scores from step 222 (in connection with the membership functions).

Further, step 228 includes scoring one or more resources using the fuzzy model. For example, in one or more embodiments, the fuzzy model can be used to score (e.g., a score between 0 and 100 to represent a level of matching to the first enterprise resource(s)), relative to one or more products of a first enterprise, one or more similar products of at least a second enterprise. In at least one embodiment, the fuzzy model is applied to competitor data files on a daily basis and pricers review the results and identify one or more exclusions.

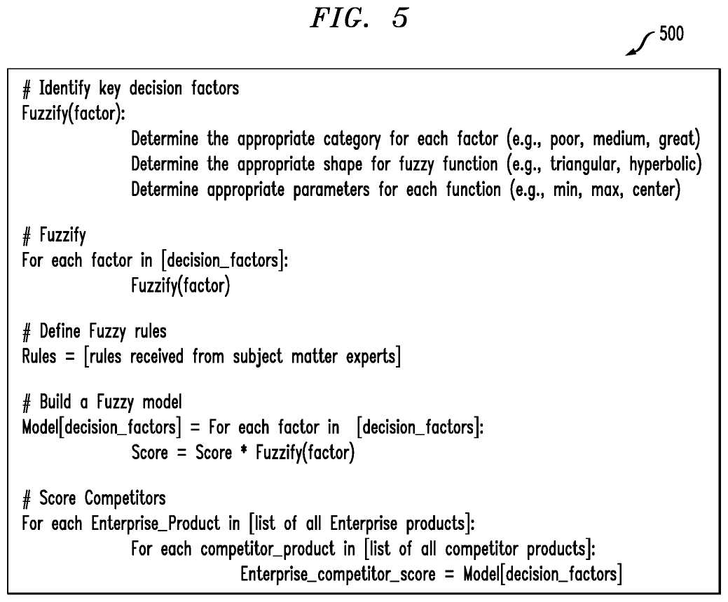

FIG. 4 shows an example graph 400 depicting fuzzy membership in connection with resource quality in an illustrative embodiment. In example graph 400, the x-axis pertains to the quality of the match between an enterprise product and a competitor product, presented in terms of values between 0 and 100 (determined, e.g., by the fuzzy model). As such, if a score is, for example, close 100, then the match is considered great (i.e., the membership value would be close to 1).

By way of example, a particular enterprise competitor product mapping has (relative to an enterprise product) a 53% price difference and two different hardware specifications. This mapping gets a score of 24, illustrated by the bold black line 440 in graph 400, below a defined exclusion threshold, depicted by shaded region 442 (e.g., which can be defined based at least in part on pricer input). As a result, this mapping will be excluded from the pricing process because it has been deemed insufficiently relevant.

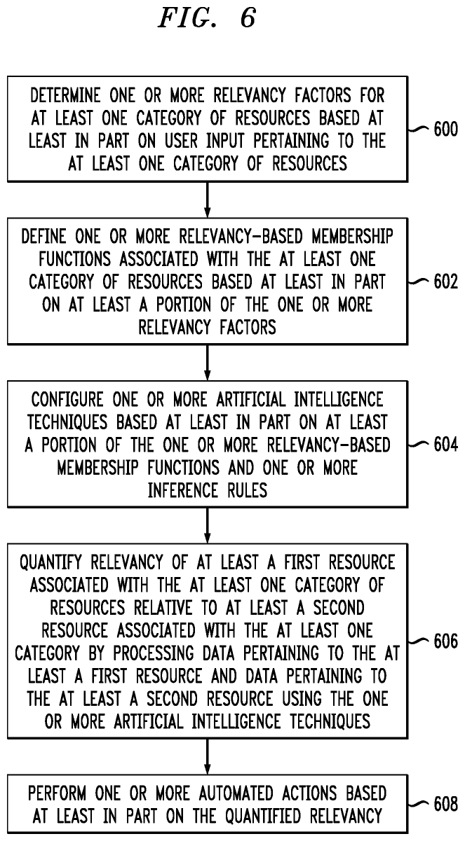

FIG. 5 shows example pseudocode for implementing a fuzzy model to quantify relevancy of resources using in an illustrative embodiment. In this embodiment, example pseudocode 500 is executed by or under the control of at least one processing system and/or device. For example, the example pseudocode 500 may be viewed as comprising a portion of a software implementation of at least part of automated resource relevancy quantification system 105 of the FIG. 1 embodiment.

The example pseudocode 500 illustrates identifying key decision factors, which includes determining the correct and/or appropriate category (e.g., poor, medium or great, as used in the example embodiments of FIG. 3 and FIG. 4) for each factor (e.g., price difference, number of specification differences, etc.). Example pseudocode 500 also illustrates determining the correct and/or appropriate shape (e.g., triangular, hyperbolic) for at least one fuzzy function, which can include, for example, determining the correct and/or appropriate parameters (e.g., min, max, center) for each fuzzy function. In at least one embodiment, the shape of the at least one fuzzy function determines how quickly the quality of match changes depending on a change in at least one contributing factor (e.g., a 10% change in price difference results in a 10% drop in match quality, etc.).

As also illustrated in FIG. 5, example pseudocode 500 includes fuzzifying each factor in the set of identified key decision factors. Additionally, example pseudocode 500 illustrates defining one or more fuzzy rules, which can be based at least in part, for example, on rules and/or information received from subject matter experts related to the resources in question. Example pseudocode 500 also illustrates building a fuzzy model using, for example, at least a portion of the one or more defined fuzzy rules, wherein the fuzzy model can be implemented to generate a score representing a level of relevance for a given resource relative (e.g., a competitor's hardware device or product) to another resource (an inquiring enterprise's hardware device or product). By way of example, for each factor in the set of identified key decision factors, the score can be multiplied by the fuzzified factor.

It is to be appreciated that this particular example pseudocode shows just one example implementation of implementing a fuzzy model to quantify relevancy of resources, and alternative implementations can be used in other embodiments.

In one or more embodiments, at least one fuzzy model can be trained based at least in part on pricer experience data with limited historical data, and such a trained model can be implemented to quantify subjectivity within pricer decisions. Additionally or alternatively, the trained model can be implemented to quantify the relevancy of one or more resources with respect to at least one resource parameter (e.g., practical useful lifetime of the resource).

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on resource-related data, one or more membership functions, and/or one or more fuzzy rules, and such recommendations and/or predictions can be used to initiate one or more automated actions (e.g., precluding particular resource data from one or more processing tasks, automatically training and/or tuning one or more artificial intelligence techniques (e.g., a fuzzy model), etc.).

FIG. 6 is a flow diagram of a process for quantifying relevancy of resources using artificial intelligence techniques in an illustrative embodiment. It is to be understood that this particular process is only an example, and additional or alternative processes can be carried out in other embodiments.

In this embodiment, the process includes steps 600 through 608. These steps are assumed to be performed by automated resource relevancy quantification system 105 utilizing elements 112, 114 and 116.

Step 600 includes determining one or more relevancy factors for at least one category of resources based at least in part on user input pertaining to the at least one category of resources. In at least one embodiment, the at least one category of resources includes at least one category of hardware devices, and wherein determining one or more relevancy factors includes identifying one or more specification discrepancies across hardware devices associated with the at least one category. Additionally or alternatively, determining one or more relevancy factors can include identifying one or more value discrepancies across resources associated with the at least one category of resources.

Step 602 includes defining one or more relevancy-based membership functions associated with the at least one category of resources based at least in part on at least a portion of the one or more relevancy factors. In one or more embodiments, defining one or more relevancy-based membership functions includes defining one or more relevancy-based fuzzy membership functions, and wherein defining one or more relevancy-based fuzzy membership functions includes determining one or more shapes to be associated with the one or more relevancy-based fuzzy membership functions. Additionally or alternatively, defining one or more relevancy-based membership functions can include determining one or more value-based parameters to be implemented in connection with each of the one or more relevancy-based membership functions.

Step 604 includes configuring one or more artificial intelligence techniques based at least in part on at least a portion of the one or more relevancy-based membership functions and one or more inference rules. In at least one embodiment, configuring one or more artificial intelligence techniques includes configuring at least one fuzzy model based at least in part on at least a portion of the one or more relevancy-based membership functions and one or more inference rules. In such an embodiment, defining one or more relevancy-based membership functions can include fuzzifying data associated with the one or more relevancy factors. Also, in such an embodiment, configuring one or more artificial intelligence techniques can include defining the one or more inference rules by defining one or more fuzzy rules based at least in part on at least a portion of the one or more relevancy-based membership functions.

Step 606 includes quantifying relevancy of at least a first resource associated with the at least one category of resources relative to at least a second resource associated with the at least one category by processing data pertaining to the at least a first resource and data pertaining to the at least a second resource using the one or more artificial intelligence techniques. In one or more embodiments,

Step 608 includes performing one or more automated actions based at least in part on the quantified relevancy. In at least one embodiment, performing one or more automated actions includes automatically excluding data pertaining to at least one of the at least a first resource and the at least a second resource from one or more data processing tasks. Additionally or alternatively, performing one or more automated actions can include automatically training at least a portion of the one or more artificial intelligence techniques based at least in part on feedback related to the quantified relevancy.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to identify and quantify relevancy of resources using artificial intelligence techniques. These and other embodiments can effectively overcome problems associated with error-prone and labor-intensive efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a CPU, a GPU, a TPU, a microcontroller, an ASIC, a FPGA or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
determining one or more relevancy factors for at least one category of resources based at least in part on user input pertaining to the at least one category of resources;
defining one or more relevancy-based membership functions associated with the at least one category of resources based at least in part on at least a portion of the one or more relevancy factors;
configuring one or more artificial intelligence techniques based at least in part on at least a portion of the one or more relevancy-based membership functions and one or more inference rules;
quantifying relevancy of at least a first resource associated with the at least one category of resources relative to at least a second resource associated with the at least one category by processing data pertaining to the at least a first resource and data pertaining to the at least a second resource using the one or more artificial intelligence techniques; and
performing one or more automated actions based at least in part on the quantified relevancy;
wherein the method is performed by at least one processing device comprising a processor coupled to a memory.

2. The computer-implemented method of claim 1, wherein performing one or more automated actions comprises automatically excluding data pertaining to at least one of the at least a first resource and the at least a second resource from one or more data processing tasks.

3. The computer-implemented method of claim 1, wherein performing one or more automated actions comprises automatically training at least a portion of the one or more artificial intelligence techniques based at least in part on feedback related to the quantified relevancy.

4. The computer-implemented method of claim 1, wherein configuring one or more artificial intelligence techniques comprises configuring at least one fuzzy model based at least in part on at least a portion of the one or more relevancy-based membership functions and one or more inference rules.

5. The computer-implemented method of claim 4, wherein defining one or more relevancy-based membership functions comprises fuzzifying data associated with the one or more relevancy factors.

6. The computer-implemented method of claim 4, wherein configuring one or more artificial intelligence techniques comprises defining the one or more inference rules by defining one or more fuzzy rules based at least in part on at least a portion of the one or more relevancy-based membership functions.

7. The computer-implemented method of claim 1, wherein defining one or more relevancy-based membership functions comprises defining one or more relevancy-based fuzzy membership functions, and wherein defining one or more relevancy-based fuzzy membership functions comprises determining one or more shapes to be associated with the one or more relevancy-based fuzzy membership functions.

8. The computer-implemented method of claim 1, wherein defining one or more relevancy-based membership functions comprises determining one or more value-based parameters to be implemented in connection with each of the one or more relevancy-based membership functions.

9. The computer-implemented method of claim 1, wherein the at least one category of resources comprises at least one category of hardware devices, and wherein determining one or more relevancy factors comprises identifying one or more specification discrepancies across hardware devices associated with the at least one category.

10. The computer-implemented method of claim 1, wherein determining one or more relevancy factors comprises identifying one or more value discrepancies across resources associated with the at least one category of resources.

11. A non-transitory processor-readable storage medium having stored therein program code of one or more software programs, wherein the program code when executed by at least one processing device causes the at least one processing device:
to determine one or more relevancy factors for at least one category of resources based at least in part on user input pertaining to the at least one category of resources;
to define one or more relevancy-based membership functions associated with the at least one category of resources based at least in part on at least a portion of the one or more relevancy factors;
to configure one or more artificial intelligence techniques based at least in part on at least a portion of the one or more relevancy-based membership functions and one or more inference rules;
to quantify relevancy of at least a first resource associated with the at least one category of resources relative to at least a second resource associated with the at least one category by processing data pertaining to the at least a first resource and data pertaining to the at least a second resource using the one or more artificial intelligence techniques; and
to perform one or more automated actions based at least in part on the quantified relevancy.

12. The non-transitory processor-readable storage medium of claim 11, wherein performing one or more automated actions comprises automatically excluding data pertaining to at least one of the at least a first resource and the at least a second resource from one or more data processing tasks.

13. The non-transitory processor-readable storage medium of claim 11, wherein configuring one or more artificial intelligence techniques comprises configuring at least one fuzzy model based at least in part on at least a portion of the one or more relevancy-based membership functions and one or more inference rules.

14. The non-transitory processor-readable storage medium of claim 13, wherein defining one or more relevancy-based membership functions comprises fuzzifying data associated with the one or more relevancy factors.

15. The non-transitory processor-readable storage medium of claim 13, wherein configuring one or more artificial intelligence techniques comprises defining the one or more inference rules by defining one or more fuzzy rules based at least in part on at least a portion of the one or more relevancy-based membership functions.

16. An apparatus comprising:
at least one processing device comprising a processor coupled to a memory;
the at least one processing device being configured:
to determine one or more relevancy factors for at least one category of resources based at least in part on user input pertaining to the at least one category of resources;
to define one or more relevancy-based membership functions associated with the at least one category of resources based at least in part on at least a portion of the one or more relevancy factors;
to configure one or more artificial intelligence techniques based at least in part on at least a portion of the one or more relevancy-based membership functions and one or more inference rules;
to quantify relevancy of at least a first resource associated with the at least one category of resources relative to at least a second resource associated with the at least one category by processing data pertaining to the at least a first resource and data pertaining to the at least a second resource using the one or more artificial intelligence techniques; and
to perform one or more automated actions based at least in part on the quantified relevancy.

17. The apparatus of claim 16, wherein performing one or more automated actions comprises automatically excluding data pertaining to at least one of the at least a first resource and the at least a second resource from one or more data processing tasks.

18. The apparatus of claim 16, wherein configuring one or more artificial intelligence techniques comprises configuring at least one fuzzy model based at least in part on at least a portion of the one or more relevancy-based membership functions and one or more inference rules.

19. The apparatus of claim 18, wherein defining one or more relevancy-based membership functions comprising fuzzifying data associated with the one or more relevancy factors.

20. The apparatus of claim 18, wherein configuring one or more artificial intelligence techniques comprises defining the one or more inference rules by defining one or more fuzzy rules based at least in part on at least a portion of the one or more relevancy-based membership functions.
